(19) United States
(12) Patent Application Publication
(10) Pub. No.: US 2003/0151701 A1
(43) Pub. Date: Aug. 14, 2003

(54) Television monitor with ceiling and wall mounting system

(76) Inventor: Marty Sedighzadeh, Littleton, CO (US)

Correspondence Address: Kurt P. Leyendecker, Dorsey & Whitney LLP, 370 17th Street, Suite 4700, Denver, CO, 80202-5647, US

(21) Appl. No.: 10/209,996

(22) Filed: Jul. 22, 2002

Related U.S. Application Data
(60) Provisional application No. 60/355,982, filed on Feb. 12, 2002.

(51) Int. Cl. H04N 5/645

(52) U.S. Cl. 348/825; 348/831

(57) ABSTRACT

A television mounting system including a television monitor specifically adapted for mounting on a ceiling or a wall is described. The television monitor includes mounting connectors proximate the top of the left, right and rear sides of the monitor's housing. A ceiling bracket is provided to which the connectors are affixed. The ceiling bracket includes a swivel connector that may be mounted to a ceiling. Each of the left and right sides of the housing further include at least two connectors to redundantly secure the television to the ceiling bracket to provide additional safety. A wall bracket is also provided that is adapted to be coupled with the ceiling bracket, thereby permitting the monitor to be attached to a vertical surface.

### CROSS REFERENCE TO RELATED APPLICATIONS

This application claims priority to U.S. Provisional Application No. 60/355,982 filed Feb. 12, 2002.

### BACKGROUND OF THE INVENTION

1. Field of the Invention

This invention relates generally to television monitors, and more specifically to a television monitor and associated support structure for interchangeability mounting the monitor to a wall or ceiling.

2. Description of the Prior Art

Many types of bracketry and shelving are known in the art for mounting a stand alone cathode ray tube type television monitor to a wall or a ceiling. Examples include U.S. Pat. Nos. 5,148,282 and 5,139,223, both issued to the inventor of the present invention. As illustrated in these exemplary patents, prior art mounting systems are generally of two types: (1) a mounting system incorporating a shelf on which the monitor is placed U.S. Pat. No. (5,148,282) and (2) a mounting system using straps or similar structure to support the television monitor U.S. Pat. No. (5,139,223).

The shelving and other components of such mounting systems may not be aesthetically pleasing and accordingly, a cover may be required to hide the components. As can be appreciated the need for a cover can increase the total cost for the mounting system/television monitor combination since the monitor, which already has a housing designed to be aesthetically pleasing, must be covered with another cover to hide the bracketry associated with the mounting system.

Further, a mounting system to be used with a typical television monitor must be designed to support the monitor from below, since the chassis and housing of a typical monitor that is designed for being placed on a support surface can not be suspended from its top or side. Accordingly, any mounting system must at least partially support the television from the bottom, thereby requiring additional and more costly bracketry than if the television could be supported from above.

Several mounting system/television monitor combinations are known, such as disclosed in published PCT application WO 97/14248 ('248) and U.S. Pat. No. 4,727,598 ('598) of Ehlers. The '598 reference teaches a television monitor that has two slots that can be slidably received into a corresponding T-mount that is mounted to the underside of a kitchen cabinet. This system is not optimized for mounting on a ceiling since the viewing surface of the television cannot be tilted downwardly. The mounts do not permit the television to be rotated, and additionally, the integrated mounting system does not provide for mounting the television on a vertical surface such as a wall.

The '248 reference teaches a television monitor that is mounted to a ceiling through a plate and tube mounting bracket that is bolted to the top of the television housing. The nature of the mounting bracket does not permit the television to be easily and safely mounted to the ceiling and would typically require two people to attach the television to a ceiling: one to hold the television and the other to tighten the necessary fasteners. Further, the mounting bracketry is exposed and not hidden from view, which is not aesthetically pleasing.

### BRIEF SUMMARY OF THE INVENTION

A television monitor mounting system comprising a monitor designed specifically for attachment to a ceiling or wall and the associated bracketry is described. In one preferred embodiment, the monitor mounting system includes framework adapted for pivotal attachment to a ceiling along with a monitor that has a housing adapted for mounting to the framework. Specifically, the housing includes (i) a front side having a viewing surface, (ii) a rear side opposite the front side, and (iii) left and right sides that extend between respective left and right edges of the front and rear sides. The right side has one or more connection devices extending from it that are adapted to couple with a right end of a frame member of the framework. Similarly, the left side has one or more connection devices extending from it that are adapted to couple with a left end of a frame member of the framework.

In variations of this preferred embodiment, multiple connection devices, such as looped cords, elongated plate members with apertures therein, and locking mechanisms, are used to couple with each of the left and right ends of the frame members. Further in other variations, the framework includes a rear side wherein the framework is coupled with the housing of the monitor proximate the rear side of the housing.

In another preferred embodiment, the monitor mounting system comprises a monitor having a housing with one or more mounting connectors located proximate the top side of the housing. Additionally, the system includes a monitor mounting bracket that is adapted to couple with the monitor at the mounting locations. The monitor mounting bracket has a swivel anchor adapted for pivotally mounting the monitor to a ceiling. Further, the system includes a wall mounting bracket adapted to pivotally couple the monitor mounting bracket to a vertical surface.

In a third preferred embodiment, the monitor mounting system comprises a monitor having two or more connectors located proximate a top edge of a left side of the monitor and two or more connectors located proximate a top edge of a right side of the monitor. Further, a ceiling bracket is provided that is adapted to attach with the two or more connectors of the left side and the two or more connectors of the right side. Additionally, the ceiling bracket includes a swivel connector for pivotally mounting with a ceiling.

Other embodiments are contemplated as evidenced from the detailed description and the appended claims provided below.

### BRIEF DESCRIPTION OF THE DRAWINGS

FIG. 1 is an isometric front view of the television monitor of the present invention mounted to a wall.

FIG. 2 is an isometric front view of the television monitor of the present invention mounted flush with to a ceiling.

FIG. 3 is an isometric front view of the television monitor of the present invention suspended below a ceiling by a support pillar assembly.

FIG. 4 is an isometric top view of the television monitor and an associated T-bracket for flush mounting to a ceiling according to the present invention.

FIG. 5 is an isometric top view of the television monitor and an associated T-bracket and pillar assembly for suspending the monitor below a high ceiling, such as one made of concrete, according to the present invention.

FIG. 6 is a cross sectional side view of the television monitor and associated wall mount bracketry taken along line 6-6 of FIG. 1.

FIG. 7 is a cross sectional side view of the television monitor and associated ceiling mount bracketry taken along line 7-7 of FIG. 2.

FIG. 8 is a partial cross sectional view along line 8-8 of FIG. 7 illustrating the attachment of one of the left and right sides of the television monitor to the T-bracket.

FIG. 9 is a similar view as FIG. 8 showing the metal support structure of the housing and the associated locking mechanism prior to attachment to one of the side ends of the T-bracket.

FIG. 10 is an isometric view of the interface between the side end of the T-bracket and the associated metal attachment structure and locking mechanism of the television monitor housing.

FIG. 11 is an exploded isometric view of the interface between the rear end of the T-bracket and the associated metal attachment structure of the television monitor along with the bracketry for attaching the T-bracket to a wall.

FIG. 12 is an isometric top view of the T-bracket according to one embodiment of the present invention.

### DETAILED DESCRIPTION OF THE INVENTION

A television monitor and mounting system combination for interchangeably mounting the monitor to a ceiling or a wall is described. Support structure is integrally molded into the monitor housing to permit easy and secure attachment of the monitor to a ceiling or a wall via a T-shaped bracket and other associated mounting hardware. A triple redundant mounting system incorporating support straps, elongated metal support plates and a locking mechanism is provided so that the monitor can be easily mounted to the T-bracket by a single person. Further, the triple redundant mounting system assures that the monitor is safely secured above and discourages theft of the television monitor.

The Television Monitor

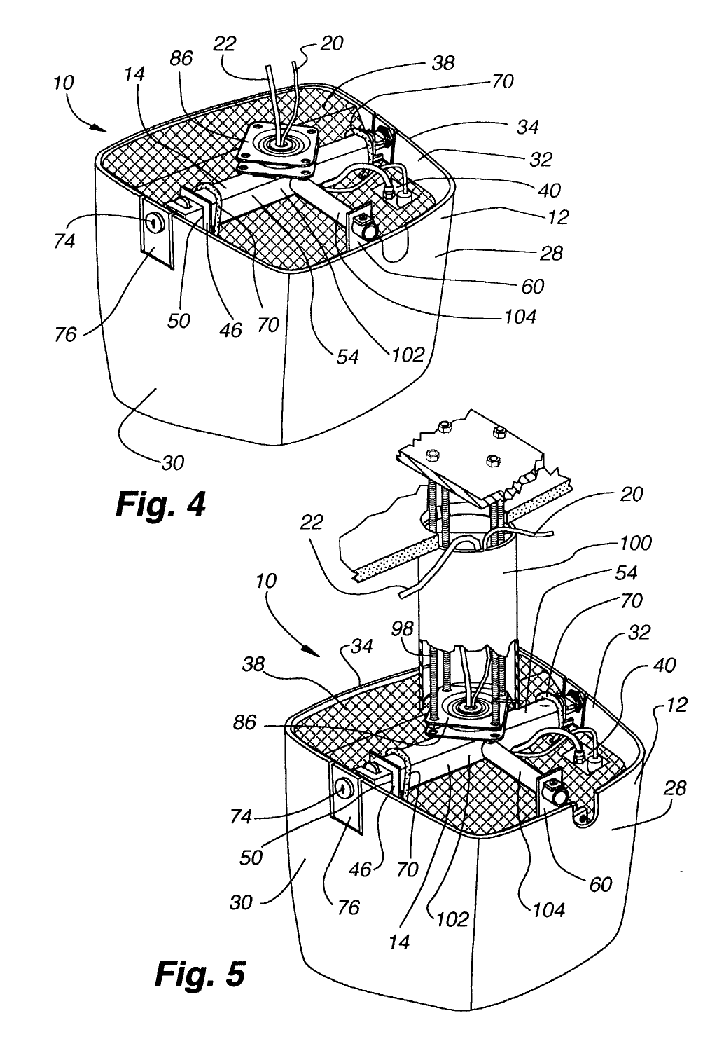

Referring to FIGS. 4, 7 and 8-10, the television monitor housing 12 is constructed to facilitate attachment to a T-shaped bracket 14 (described in detail below) at the top side of the monitor 10. As shown in FIG. 7, the television monitor includes a circuit board 16, typically fabricated from a fiberglass composite material to which electrical circuitry of the television is mounted. Brackets extend from the circuit board and support a cathode ray tube 18. Further, at least one power cable 20 and an signal receiving cable 22, which are electrically coupled to the television circuitry extend from the circuit board. The circuit board rests against the bottom side 24 of the housing.

The housing 12 is typically fabricated from a molded plastic that may or may not be reinforced with a fibrous material, such as fiberglass. From the bottom side 24, the housing extends upwardly in a generally vertical direction to form a front side 26, rear side 28, a left side 30 and a right side 32 with all the sides terminating at a top edge 34 of the housing. The front side typically includes a rectangular opening through which the CRT 18 is viewed. The edges of the CRT abut the lipped edges 36 of the front side.

Referring to FIGS. 4 and 5, the top of the housing 12 is typically open but a perforated grate 38 is typically received therein to rest below the top edge 34 of the housing. The grate, which is typically fabricated of a molded plastic, prevents easy access to the electronic circuitry of the monitor and permits air to circulate out of the housing to prevent the circuitry from overheating during use. In a preferred embodiment, a receptacle box 40 is molded into the grate in which an electrical plug 42 and a coaxial cable socket 44 are affixed. The plug 42 is coupled with the power cable 20 and the coaxial socket 44 is coupled with the signal receiving cable 22. Accordingly sources of external power and television signals can be coupled with the monitor for operation.

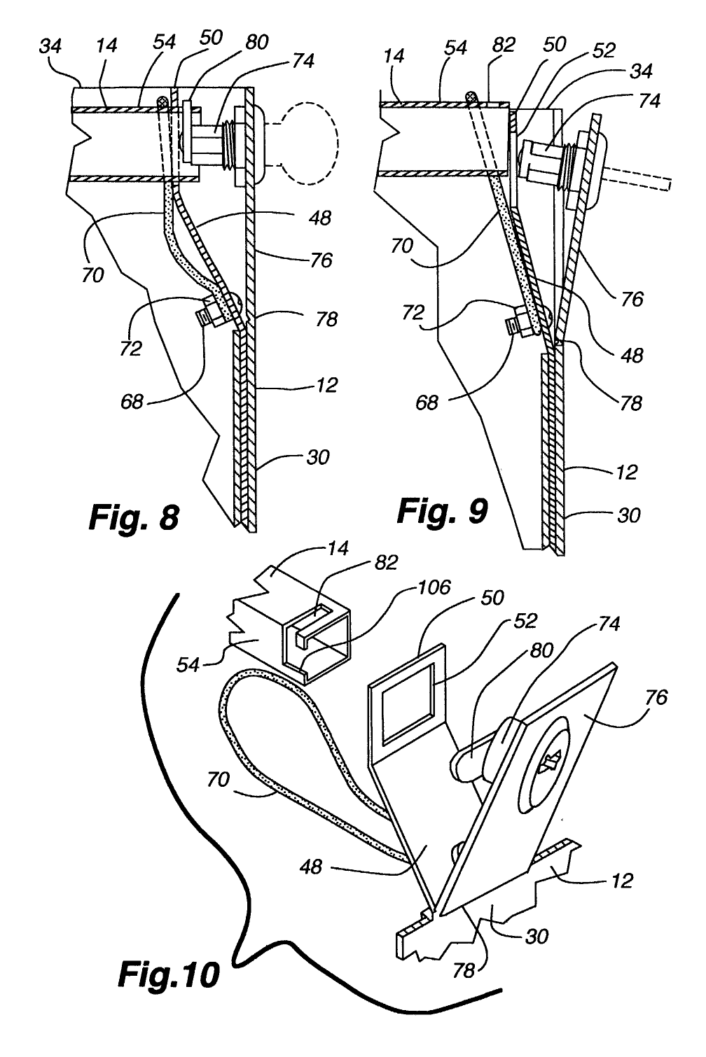

A elongated metal plate member 46 bent into a U-shape is imbedded in the housing. The U-shaped plate member 46, which is typically several inches wide, is preferably embedded in the bottom, left and right sides 24, 28 and 30 of the housing 12 at a front to rear location that corresponds to the television monitor's center of gravity. As best shown in FIGS. 8 and 9, each side 48 of the U-shaped plate member extends upwardly and generally vertically embedded within the corresponding left or right side of the housing and emerges inwardly from the corresponding side at a location below the top edge 34 of the housing. Each side of the U-shaped plate member extends inwardly for a short distance until being bent back to a generally vertical orientation, wherein it extends upwardly to a top edge 50. The top edge of each side of the plate member is roughly coplanar with the top edge of the housing. A rectangular aperture 52 that is sized to receive a corresponding arm 54 of the T-shaped bracket 14 is provided in each side of the plate member proximate the side's top edge.

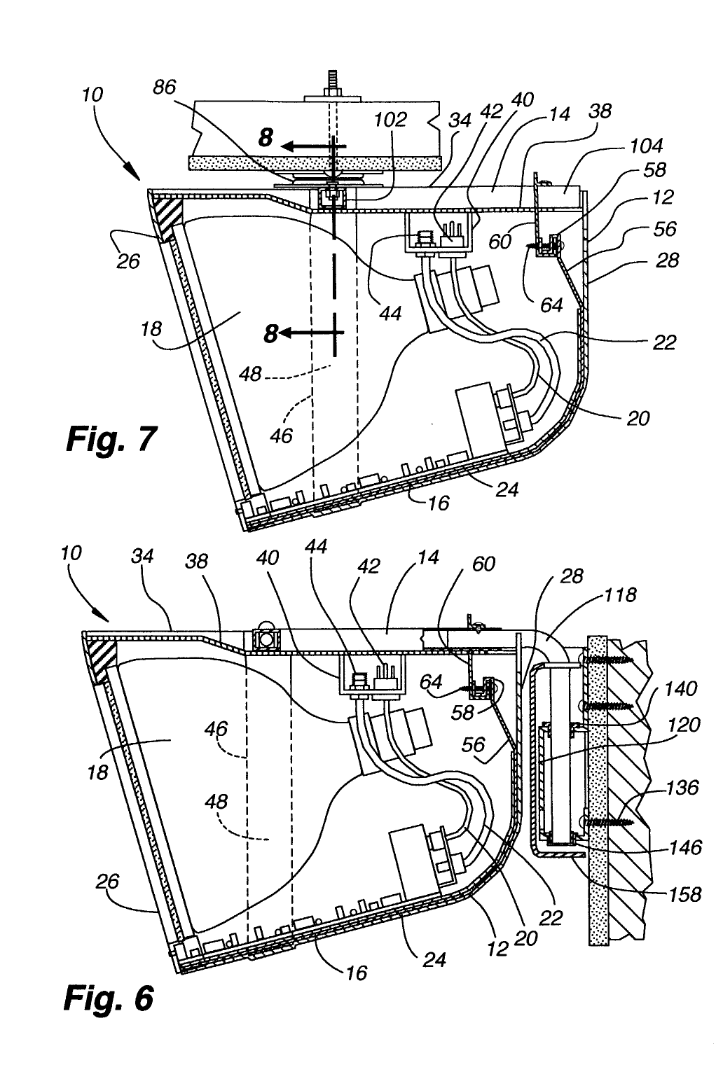

Referring primarily to FIGS. 6 and 7, at a location corresponding to the center of the U-shaped plate member 46 at the bottom side 24 of the housing 12, the front end of an L-shaped elongated plate member 56 is secured (preferably welded) to the U-shaped plate member and extends rearwardly embedded in the bottom side of the housing until intersecting with the rear side 28 of the housing wherein it bends coextensively with the housing and extends upwardly embedded in the rear side. At a location approximately halfway between the bottom side and the top edge of the housing, the L-shaped plate emerges from the rear side and bends inwardly at an acute angle. The top end of the L-shaped plate is bent to form a coupling portion 58 comprising a plurality of horizontal and vertical sides that are configured to be received in a responding J-shaped structure of a coupling bracket 60 that is attached to the T-bracket 14 as will be described below. Horizontally extending apertures 62, preferably threaded, are provided though the coupling portion to receive fasteners 64 to fixedly join the L-shaped bracket to the coupling bracket.

Referring to FIGS. 8 and 9, proximate where each of the sides 48 of the U-shaped plate member diverge from the respective left or right side of the housing, there is a small aperture therein through which a bolt 68 is received. A flexible looped strap 70, preferably comprised of a braided metal mesh cord although cords of other construction may be used, is attached to the bolt with a corresponding nut 72. The strap is sized to be looped over a corresponding arm 54 of the T-bracketry for reasons that will become apparent. Further, a locking mechanism 24 is provided on each side of the housing that can be utilized to secure the corresponding side of the elongated U-shaped plate member to an arm of the T-bracket. In a preferred embodiment, the locking mechanism is attached to an ear 76 of the corresponding side of the housing that is attached to the housing through a living hinge 78 at its bottom edge. The ear typically has a top edge that corresponds to the top edge 34 of the housing. Accordingly, the locking mechanism can be moved out of the way when the television monitor is being mounted and swung back in place with a tongue 80 of the locking mechanism being received into a slot 82 in the arm of the T-bracket to secure the monitor in place.

The T-Bracket Assembly

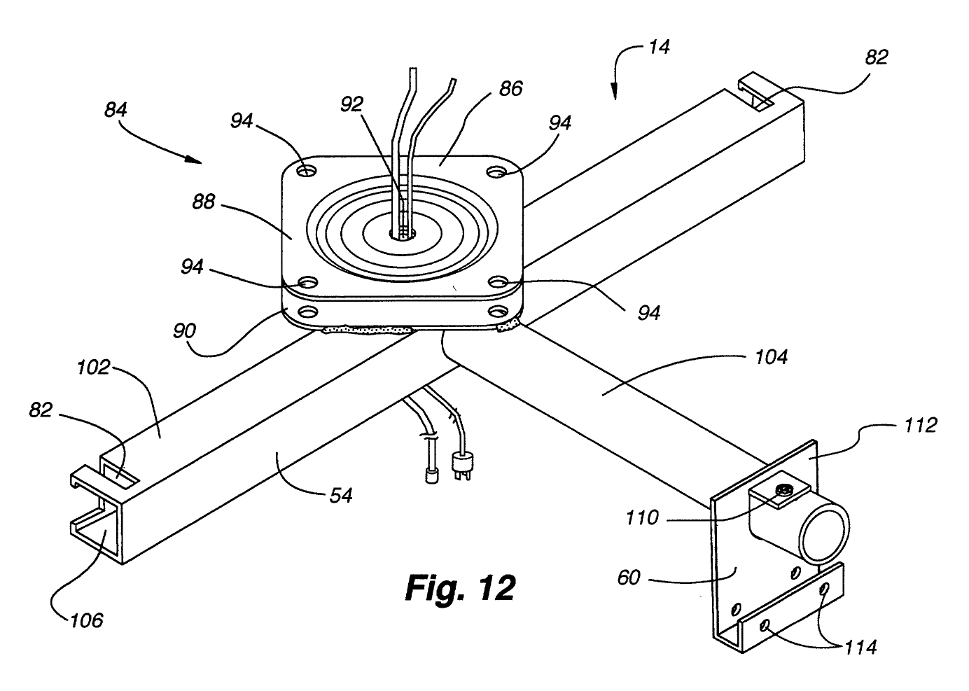

Referring primarily to FIG. 12 the T-bracket assembly 84 includes (i) a turntable anchor 86, (ii) the T-bracket 14, and (iii) the coupling bracket 60. The turntable anchor is of a relatively conventional type having an upper plate 28, a lower plate 90 and a low friction bearing system therebetween (not shown) so that the plates are relatively pivotable about a vertical axis as viewed in FIG. 12. The center of the turntable anchor has an opening 92 therethrough to receive power and signal receiving cables as will be explained in more detail later. A stop (not shown) is typically provided to prevent the turntable from turning more than a single rotation, thereby preventing excessive twisting of the power and signal receiving cables that extend through the turntable.

The upper and lower plates 88 and 90 of the turntable 86 respectively are typically of a generally square configuration with the upper plate having four holes 94 therethrough disposed in each comer of the plate. The holes are adapted to receive screw-type fasteners to fasten the turntable to a ceiling joist or the like. As will be appreciated, the four holes define two pair of diametrically opposed but aligned holes, either pair of which can be positioned along the length of a ceiling joist or ceiling so that at least two screw-type fasteners can be anchored in the ceiling joist or other ceiling surface. Access to each fastener with a screwdriver or the like is easily obtained by rotating the bottom plate relative to the top plate so that they are approximately 45 degrees offset. The bottom plate of the turntable is typically welded or otherwise secured to a top side of the T-bracket 14 proximate the intersection of the “T”. As can be best seen in FIG. 12, the turntable is positioned such that its center opening 92 is located in front of a front side of the T-bracket permitting cables to pass therethrough unhindered.

In an alternative configuration as illustrated in FIGS. 3 and 5, the television monitor can be suspended from the ceiling by a pillar assembly instead of being mounted flush with the ceiling. A typical pillar assembly comprises four elongated all-threaded bolts 98 that are received through the four holes of the turntable's top plate and secured to a joist or other support in a ceiling. For aesthetic purposes, the pipe 100 is provided that covers the all-threaded bolts. The pipe is typically comprised of a plastic material such as PVC and is finished to match the housing of the monitor.

The T-bracket 14 comprises a rectangular first tubular member 102 that forms the arms 54 of the T-bracket and a circular second tubular member 104 that extends from the center of the first tubular member forming the leg of the T-bracket. Preferably the second tubular member is welded to the first tubular member, although they may be immovably joined by other means as well, such as mechanical fastening. Each of the ends of the first tubular member is open to receive the locking mechanism 74 therein. A generally rectangular cutaway 106 is provided on the front side of each end of the first tubular member from which a slot 82 extends into the top side. The slot is positioned to receive the tongue 80 of the locking mechanism for securing the end of the U-shaped plate member 46 on the first tubular member. Alternatively, the lock mechanism may be located substantially outside of the first tubular member with a tongue of the lock being received into a slot in the first tubular member. The rear end of the second tubular member is also open for receiving an L-shaped plate member 56 therein when the T-bracket and the monitor are mounted on a wall as will be described below.

As briefly mentioned above, a coupling bracket 60 is mounted onto the second tubular member 104 proximate the tubular member's rear end. In the preferred embodiment, the coupling bracket 60 (as best shown in FIG. 12) includes an aperture 108 which is slid over the end of the second tubular member and secured in place by a coupling fastener 10 that extends through a hole in a rearwardly extending tongue 112 of the coupling bracket and a threaded aperture in the second tubular member. The coupling bracket is bent into a J-shape with aligned fastener holes 114 extending through the generally vertical sides of the “J”. As mentioned above and discussed in greater detail below, the slot formed in the bottom of the J-shaped coupling bracket is configured to receive the coupling portion 58 of the L-shaped plate member 46.

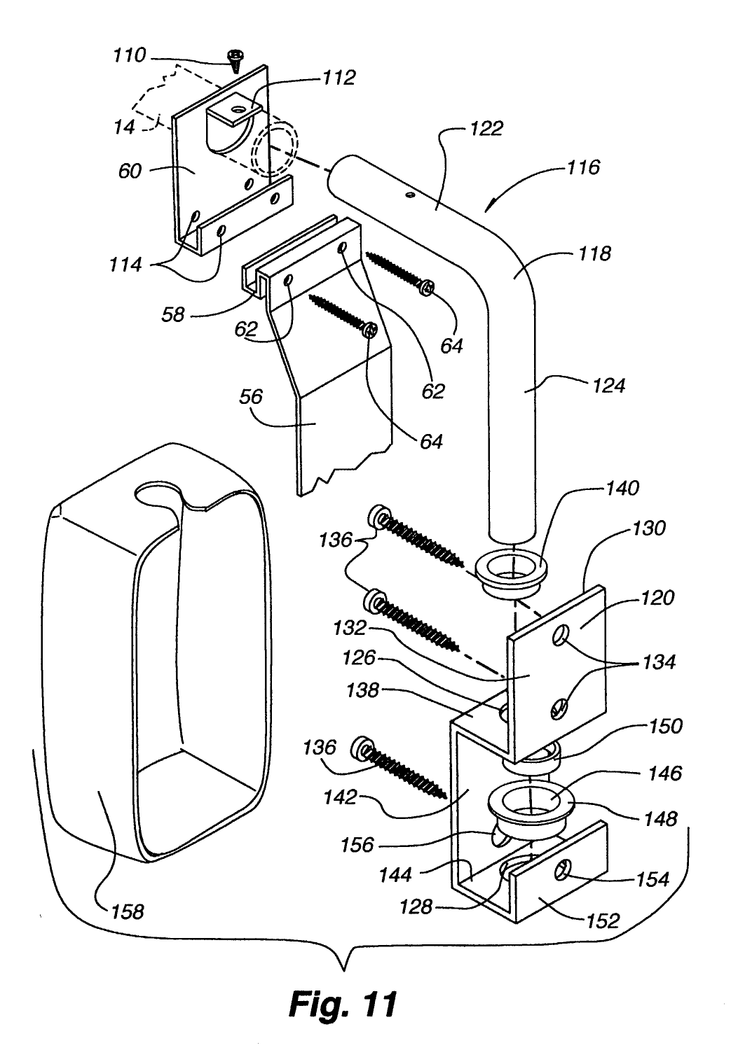

In FIGS. 6 and 11, a wall mount assembly 116 is illustrated that can be utilized to mount the T-bracket and the associated monitor to a wall instead of to a ceiling. The major components of the wall mount assembly include an L-shaped tubular member 118 and a wall mounting bracket 120. The L-shaped tubular member in its orientation of use has a generally horizontal leg 122 and a generally vertical leg 124. The diameter of the L-shaped tubular member is slightly smaller than the diameter of the second tubular member 104 of the T-bracket for slidable receipt into the second tubular member. A threaded aperture is provided through the top of the horizontal leg. When the horizontal leg is inserted into the second tubular member, the aperture is aligned with the aperture in the second tubular member, and the L-shaped tubular member is fixed to the T-bracket with the coupling fastener 110 as best shown in FIG. 6. The vertical leg 124 the L-shaped tubular member is received through vertically oriented apertures 126 and 128 in the wall mounting bracket 120.

The wall mounting bracket 120 typically comprises a piece of metal plate that has been bent into the configuration illustrated in FIG. 11. Alternatively, the mounting bracket can be fabricated from extruded stock. From a top edge 130, the mounting bracket extends vertically downwardly to form a first wall abutment side 132. Two vertically spaced holes 134 are provided in the first abutment side through which fasteners 136 are received to secure the bracket to a wall.

From the bottom of the first abutment side 132, the bracket extends generally horizontally forming a top tube receiving side 138. The top tube receiving side includes an aperture 126 passing through it. A plastic bushing/bearing 140 is typically fit into the aperture that has a inside diameter sized to receive the vertical leg 124 of the L-shaped bracket therethrough.

From a front edge of the top tube-receiving side 138, the bracket extends downwardly forming a front side 142 to provide spacing between the top tube-receiving side 138 and a bottom tube-receiving side 144. The bottom tube-receiving side extends generally horizontally rearwardly from the bottom edge of the front side. Like the top tube receiving side, the bottom tube receiving side includes an aperture 128 through it. A metal cup 146 is typically received into the aperture with a flanged rim 148 of the cup resting on the surface of the bottom tube receiving side. The bottom end of the vertical leg 124 is received in the cup and rests against the bottom of the cup. In a preferred embodiment, a plastic lower bushing/bearing 150 is also provided that spans the spacing between the sides of the cup and the outside surface of the vertical leg proximate its bottom end. Additionally, the lower busing/bearing includes an inwardly extending flange along its bottom side on which the bottom edge of the bottom edge of the vertical leg rests.

From the back edge of the bottom tube receiving side 144, the bracket extends vertically upwardly a short distance before terminating at an edge to form a second wall-abutment side 154. A hole 154 is provided in the second abutment side through which a fastener 136 is received for mounting the mounting bracket to the wall. A corresponding aligned hole 156 is also provided in the front side 142 through which a shaft of a driver can pass to secure the fastener 136 to the wall.

Referring to FIG. 6, the wall mount assembly is illustrated in its assembled configuration. The back surfaces of the first and second abutment sides 132 and 152 are flush against the wall, or a built-up structure, for heavier loads with fasteners 136 passing through the holes 134 and 154 in the abutments sides and into a stud of the wall. The vertical leg 124 of the L-shaped tubular member 118 is received in the apertures 126 and 128 of the top and bottom tube receiving sides 138 and 144 and is held in place by the plastic bushings/bearings and the metal cup 146. The bushings/bearings permit the tubular member to be pivoted relative to the bracket allowing a user to change the viewing angle of the television monitor smoothly. The horizontal leg of the L-shaped tubular member is received in the leg of the T-bracket 14 and secured therein by the coupling fastener 110. In a preferred embodiment, a finished plastic or rubber cover 158 is provided to be snapped into place over the wall mounting bracket for aesthetic purposes.

Mounting the Television Monitor

To attach a television monitor of the present invention to a ceiling as shown in FIG. 2, the T-bracket assembly 84 (as illustrated in FIG. 12) is secured to a joist or other support structure in the ceiling using two or more fasteners inserted into the holes of the upper plate 88 of the turntable 86. Either prior to or just after installing the T-bracket, the power and signal receiving cords are threaded through the center opening 92 in the turntable so that they can be connected to monitor.

Next, the installer hoists the television monitor up towards the T-bracket 14 and hooks both of the flexible looped straps 50 around the left and right arms 54 of the T-bracket. Accordingly, the installer may let go of the television monitor as it hangs from the straps thereby freeing his hands to make the other necessary installation connections and attachments. While the monitor is hanging by the two straps, the installer can connect the power and signal receiving cords to the appropriate connectors 42 and 44 in the receptacle box 40, if the connections where not previously made.

After the television monitor has been hung by the braided metal cords, the more secure connections can be made to hold the monitor in place. First, the coupling portion 58 of the L-shaped plate member 56 is placed into the T-slot of the coupling bracket 60 to support the rear of the monitor. It is to be appreciated that the coupling bracket and the leg of the T-bracket does not support much weight since most of the weight of the monitor is supported by the U-shaped plate member 46 that cradles the monitor's center of gravity. The rear connection does, however, act to rigidify and stabilize the television monitor. Once, the rear connection is made, the sides 48 of the U-shaped plate member can be connected to the left and right arms of the T-bracket. Referring to FIG. 8 and 9, each side 30 and 32 of the business 14 is raised upwardly to align the rectangular aperture 52 of the corresponding side 48 of the U-shaped plate member 46 with the corresponding arm 54 of the T-bracket until the resilient upper portion of the side of the plate member snaps onto the arm. Once both sides of the U-shaped plate member are in place on the T-bracket, the locking mechanism 74 can be swung into place and the tongues 80 of the mechanisms secured into place in the slots 82 in the T-bracket. Finally, as necessary, fasteners 64 can be secured through the aligned apertures 62 in the coupling bracket 60 and the coupling portion 58 of the L-shaped plate member to immovably secure the rear of the housing to the leg of the T-shaped bracket.

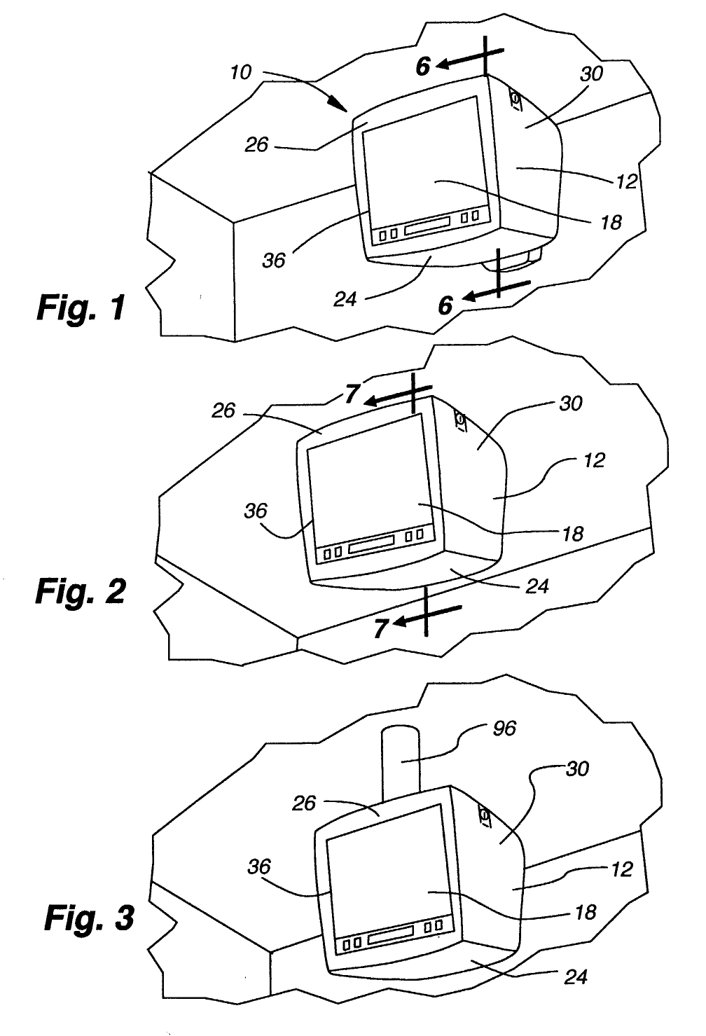

To attach the television monitor to a wall as shown in FIG. 1 using the wall mount assembly, the wall member bracket 120 is first attached to a stud or similar support in the wall using screw type fasteners 136 as illustrated in FIG. 6. Next, the L-shaped tubular member 118 is placed in and seated in the bracket. The T-bracket can be attached to the L-shaped tubular member before or after the tubular member is seated in the mounting bracket. In either case, the T-bracket is secured to the L-shaped tubular member by threading and tightening the coupling fastener 110 into the threaded hole on the horizontal leg 122 of the L-shaped tubular member. The television monitor is then attached to the T-bracket in much the same manner as described above for the flush ceiling mount.

To suspend the television monitor from a high ceiling by way of a pillar assembly as shown in FIG. 3, elongated all-threaded bolts 98 or screws are inserted through the top plate of the turntable and screwed into a ceiling joist, attached to a concrete ceiling using expansion bolts, or bolted to a support plate in the ceiling (as shown in FIG. 5). The television monitor is then attached to the T-bracket in much the same manner as described above for the flush ceiling mount.

Alternative Embodiments

Although this invention has been described with a certain degree of particularity, it is understood that the present disclosure is made by way of example, and changes in the detail, structure of manner of using the invention may be made without departing from the spirit of the invention as defined in the appended claims.

For instance, the shape and general configuration of the television monitor can vary substantially and may incorporate additional functionality such as video game counsels, DVD and video tape players and recorders, and associated audio componentry. Further, the television could be replaced entirely with a computer monitor. Although materials used to construct the various components of the invention are indicated, substitute materials are contemplated. For instance, the housing of the monitor could be comprised of a metal and the U-shaped plate member could be a reinforced polymeric material. The U-shaped plate member and the L-shaped plate member need not be embedded in the housing, rather they could be fastened or bonded to the housing in any number of conventional ways, such as riveting. Further, the ears to which the locking mechanisms are attached could be inserts completely separate from the housing or they could be attached to the housing by a conventional hinge in place of the living hinge. Numerous other differences between the disclosed monitor and an alternative embodiments as would be obvious to one of ordinary skill in the art are contemplated.

Concerning the T-bracket and other mounting hardware, the various shapes, configurations and materials utilized could vary without deviating from the spirit of the invention. For instance, the leg and arm members of the T-bracket could be shaped differently or be constructed from a different material, such as a polymeric composite. Additionally, rather than various components being welded together they could be joined with any of a number of types of fasteners. In other alternative embodiments, the manner in which the side and rear of the monitor housing are attached to the bracket could vary. In yet another embodiment, the T-bracket could be replaced with a bracket having only two connection locations or even four connection locations instead of three as described above. Numerous other differences between the disclosed brackets and mounting hardware and alternative embodiments are contemplated as would be obvious to one of ordinary skill in the art.

What is claimed is:

1. A television mounting system comprising:
a framework adapted for pivotal attachment to a ceiling, the framework including generally horizontal frame members having left and right ends thereof;
a television monitor, the television monitor having a housing, the housing including (i) a front side having a viewing surface, (ii) a rear side opposite the front side, and (iii) left and right sides extending between respective left and right edges of the front and rear sides, each of the left and right sides having one or more connection devices extending therefrom, each connection device of the one or more connection devices being adapted for coupling with the frame members proximate the respective left and right ends thereof.

2. The television mounting system of claim 1, wherein the one or more connection devices includes a looped strap.

3. The television mounting system of claim 1, wherein the one or more connection devices includes a locking mechanism.

4. The television mounting system of claim 1, wherein the one or more connection devices includes an elongated plate member having an aperture, the aperture being sized to slide over the respective left or right end of the horizontal frame members.

5. The television mounting system of claim 1, wherein the one or more connection devices comprise at least two connection devices.

6. The television mounting system of claim 1, wherein the at least two connection devices comprise two or more of a looped strap, a locking mechanism and an elongated plate member having an aperture, the aperture being sized to slide over the respective left or right end of the horizontal frame members.

7. The television mounting system of claim 1, wherein the one or more connection devices comprise at least three connection devices.

8. The television mounting system of claim 1, wherein the one or more connection devices comprises one of a generally upwardly extending left and right side of a elongated U-shaped plate member, the U-shaped plate member also having a bottom side that is coextensive with a bottom side of the housing, each of the left and right sides of the U-shaped plate member being at least partially coextensive with the respective left and right sides of the housing, each of the left and right sides and having an aperture, the aperture being the aperture being sized to slide over the respective left or right end of the horizontal frame members.

9. The television mounting system of claim 8, wherein the bottom side of the U-shaped plate member is embedded in the bottom side of the housing.

10. The television mounting system of claim 1, wherein the frame members define a T-shaped configuration having (a) a leg terminating in a rear end, (b) a left arm terminating in the left end, and (c) a right arm terminating in the right end.

11. The television mounting system of claim 10, wherein the rear side of the housing includes at least one connection device for coupling with the leg proximate the rear end thereof.

12. The television mounting system of claim 11, wherein the at least one connection device for coupling with the leg proximate the rear end thereof comprises an elongated plate member having a top end adapted for coupling with the leg, the elongated plate being at least partially coextensive with the rear side.

13. the television mounting system of claim 10, further comprising a wall mounting bracket assembly, the wall mounting bracket assembling being adapted for attachment to the leg of the frame members proximate the rear end thereof.

14. The television mounting system of claim 13, wherein the leg of the frame members is tubular and the wall mounting bracket assembly comprises (1) an L-shaped member with a generally horizontal leg and a generally vertical leg, an end of the horizontal leg being sized to be received into rear end of the tubular leg of the frame members, and (2) a mounting bracket adapted to be secured to a vertical surface, the mounting bracket further including one or more apertures adapted to pivotally receive the vertical leg of the L-shaped member.

15. A monitor mounting system comprising:
a monitor, the monitor having a housing with a front side with a viewing surface, a rear side opposite the front side, left and right sides spanning between the front and rear sides, a bottom side and a top side; the monitor further including one or more mounting connectors located proximate the top side;
a monitor mounting bracket adapted to couple with the monitor at the one or more mounting locations, the monitor mounting bracket including a swivel anchor for selectively and pivotally mounting the monitor to a ceiling; and
a wall mounting bracket adapted to pivotally couple the monitor mounting bracket to a vertical surface.

16. The monitor mounting system of claim 15, wherein the one or more mounting connectors include a right mounting connector and a left mounting connector that extend from and are located proximate respective left and right sides.

17. The monitor mounting system of claim 16, wherein the one or more mounting connectors further includes a rear mounting connector extending from and being located proximate the rear side.

18. The monitor mounting system of claim 15, wherein the top side comprises a grate.

19. The monitor mounting system of claim 15, wherein the housing comprises a polymeric material with metal elongated plates embedded therein to provide a support structure, ends of the elongated plates forming the one or more mounting connectors.

20. A monitor mounting system comprising:
a monitor having (i) two or more left connectors located proximate a top edge of a left side of the monitor and (ii)) two or more right connectors located proximate a top edge of a right side of the monitor, the right side being opposite and spaced from the left side; and
a ceiling bracket adapted to attach with the two or more left connectors and the two or more right connectors, the ceiling bracket including a swivel connector for pivotally mounting with a ceiling.

21. The monitor mounting system of claim 20, wherein the two or more left connectors comprise at least two of (a) a looped strap, (b) an elongated metal plate having an aperture adapted to fit over a portion of the ceiling bracket, and (c) a locking mechanism.

22. The monitor mounting system of claim 21, further including a wall mounting bracket adapted to connect with the ceiling bracket to pivotally mount the monitor to a vertical surface.
